(19) United States
(12) Patent Application Publication
(10) Pub. No.: US 2006/0282469 A1
(43) Pub. Date: Dec. 14, 2006

(54) Method and device for configuring a variety of medical information

(76) Inventor: William Pan, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/147,199

(22) Filed: Jun. 8, 2005

(51) Int. Cl. G06F 17/30

(52) U.S. Cl. 707/200

(57) ABSTRACT

A method and a device for configuring a variety of medical information formats are described. The method is used to incorporate a variety of medical information so as to output documents in a certain format and search for information of the patient's medication history. Thus, the device and the method are used to relieve physician's workload.

### BACKGROUND OF THE INVENTION

1. Field of the Invention

The present invention relates to a method and a device for configuring a variety of medical information, and in particular to a method and a device for converting a variety of medical information into a searchable format document by a configuration profile.

2. Description of Related Art

A patient's medical history comprises hundreds of documents when he is hospitalized. The hundreds of documents are input into computers and saved as a certain format by medical staff. Besides, every department employs different kinds of documents. For example, the WORD processor is utilized in the Otolaryngology department, while EXCEL spreadsheets are employed in the dental department. Another department uses another software to record the patient's medical history. When the medical center needs all documents recorded in the medical history to make a collective medical treatment for patients, a physician receives medical reports created by different software platforms. A lot of appliance software must be installed in a physician's computer to allow him or her to open medical reports created by the different software applications. Thus, it is not convenient for a physician to diagnose a patient's disease.

Quite a few techniques exist to solve the above problems. Taiwan Patent Publication No. 548557, entitled “A method and device for fast category searching and interconnecting”, discloses that an user provides information to generate an electronic document in a predefined document description format. Taiwan Patent Publication No. 548557 also discloses a method and a device for automatically generating related electronic documents so that users obtain search result and hyperlinks for related information generated in real time.

Taiwan Patent Publication No. 573258, entitled “A mapping method for document content and meta data”, discloses a method for mapping concept and keyword comparison to map certain paragraph of the document content to document content with different tags by meta data.

Taiwan Patent Publication No. 594532, entitled “A medical information device and a method for integrating patient's medication history information using the device”, discloses a method for integrating patient's medication history distributed in different hospitals and different departments and transmitting the patient's medication history to the user's end. According to Taiwan Patent Publication No. 594532, the method searches for a logical medication name corresponding to a medication history message so that the medical information device can retrieve a data from a database to integrate into a collective object corresponding to the logical medication name. Then, the collective object is transmitted to and displayed on terminals.

Taiwan Patent Publication No. I220485, entitled “A multicondition searching method and device for combining document conversion and similar nodes filtering”, discloses a technique for combining document conversion and similar nodes filtering. The technique is applied to search documents with multicondition to solve disadvantages of the prior art.

### SUMMARY OF THE INVENTION

It is an object of the present invention to provide a method and a device for configuring a variety of medical information and output a searchable document.

To achieve the object of the present invention, the present invention provides a method for configuring a variety of medical information format. The method includes the steps: determining whether a configuration profile exists; accessing the configuration profile stored within a storage medium; inputting a new configuration profile or modifying existent configuration profile; and saving the configuration profile to the storage medium.

The present invention provides a device for configuring a variety of medical information format. According to the present invention, the device includes a document input unit, a summary unit, a configuration profile unit and an output document unit. The document input unit is used to collect documents in a variety of medical information format, and the summary unit is used to summarize the documents in a variety of medical information formats within the document input unit in a content summary method in conformity with a configuration rule. The configuration profile unit configures documents in a variety of medical information formats within the document input unit in conformity with the configuration rule into a document in a certain format. The output document unit outputs the document in a certain format.

### BRIEF DESCRIPTION OF THE DRAWINGS

The present, invention can be fully understood from the following detailed description and preferred embodiment with reference to the accompanying drawings, in which:

FIG. 1 is a flowchart showing a method for configuring a variety of medical information according to the present invention;

FIG. 2 is a flowchart showing a summary method for configuring a variety of medical information of the present invention;

FIG. 3A schematically illustrates matches between keywords and symbols according to one embodiment of the present invention;

FIG. 3B schematically illustrates area matches according to one embodiment of the present invention; and

FIG. 4 schematically illustrates a block diagram of a device for configuring a variety of medical information formats according to the present invention.

### DETAILED DESCRIPTION OF THE PREFERRED EMBODIMENTS

The following detailed description is of the best presently contemplated modes of carrying out the invention. This description is not to be taken in a limiting sense, and is made merely for the purpose of illustrating general principles of embodiments of the invention. The scope of the invention is best defined by the appended claims.

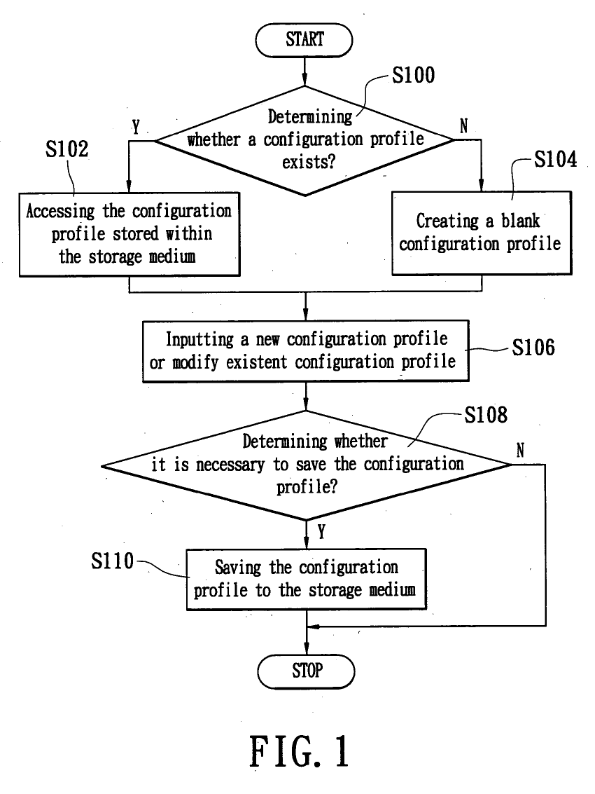

Reference is made to FIG. 1. FIG. 1 is flowchart showing a method for configuring a variety of medical information according to the present invention. The process of the flowchart is described in detail below.

Step S100: In step S100, it is determined whether a configuration profile exists. If the configuration profile exists, then the process goes to step S102. Otherwise, the process goes to step S104.

Step S102: In step S102, the present invention extracts information to generate the configuration profile and employs a portable document format to generate borderline of the configuration profile. For example, the portable document format is PDF file. Then, the process goes to step S106.

Step S104: In step S104, if the configuration profile does not exist, a blank configuration profile is created. Then, the process goes to step S106.

Step S106: In step S106, it is necessary to input a new configuration profile or modify existent configuration profile regardless of whether the configuration profile exists. Then, the process goes to step S108.

Step S108: In step S108, it is determined whether it is necessary to save the configuration profile to a storage medium. If yes, then the process goes to step S110. Otherwise, the process stops.

Step S110: In step S110, the configuration profile is saved to the storage medium.

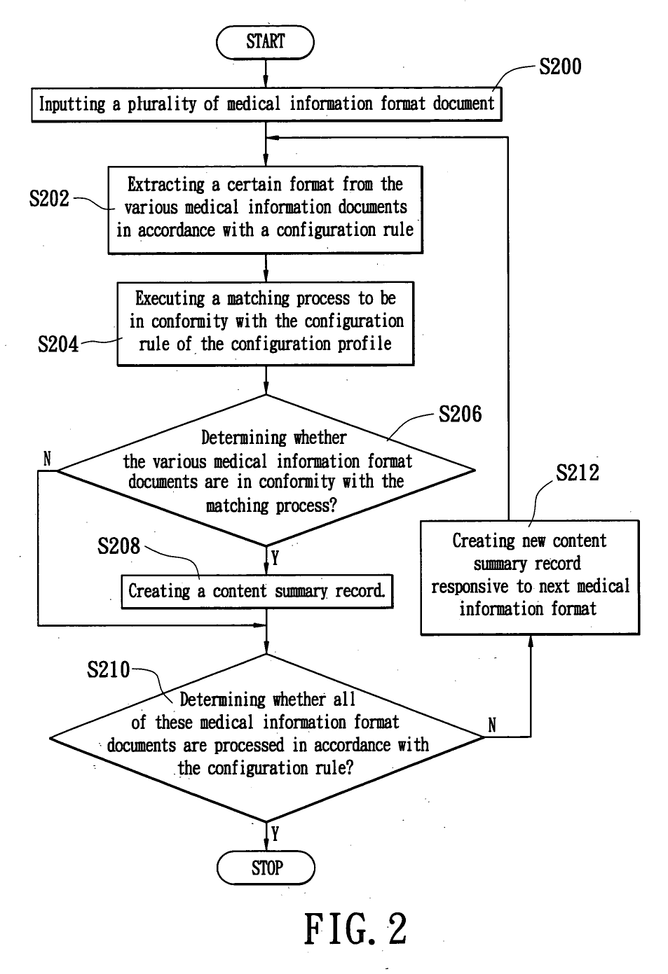

Reference is made to FIG. 2. FIG. 2 is a flowchart showing a summary method for configuring a variety of medical information of the present invention. The process of the flowchart is described in detail below.

Step S200: In step S200, a plurality of medical information format document is sequentially input. Then, the process goes to step S202.

Step S202: In step S202, a variety of medical information documents are created by word processor software. Then, various medical information documents are edited into webpage-liked medical information supported by unified resource locator (URL), or the various medical information documents are created by any one medical information format. According to configuration rule, a certain format is extracted from the various medical information documents. Then, the process goes to step S204.

Step S204: In step S204, the present invention extracts information to generate the configuration profile and employs a portable document format to generate a borderline of the configuration profile. A matching process is executed to be in conformity with the configuration rule of the configuration profile. The configuration rule can be an identification code, a patient's name, gender, symbol, or a combination thereof. Additionally, the configuration rule can be a region of interest. The matching process matches keywords/symbols, regions of interest, or combinations thereof. The keywords/symbols matching is the default, and regions of interest matching includes part of or all characters thereof. Then, the process goes to step S206.

Step S206: In step S206, it is determined whether the various medical information format documents are in conformity with the matching process. If yes, then the process goes to step S208. Otherwise, the process goes to step S210.

Step S208: In step S208, a content summary record is created. Then, the process goes to step S210.

Step S210: In step S210, it is determined whether all of these medical information format documents are processed in accordance with the configuration rule. If yes, then the process stops. Otherwise, the process goes to step S212.

Step S212: In step S212, new content summary record is created responsive to the next medical information format. Until all of medical information format documents are processed in accordance with the configuration rule, the process of content summary stops.

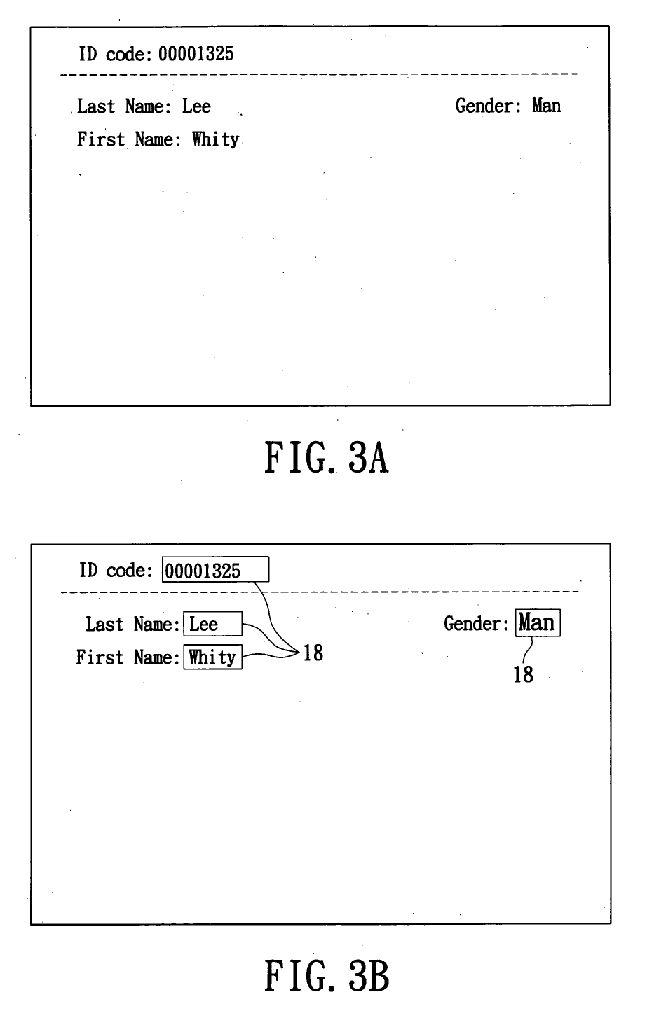

Reference is made to FIG. 3A. FIG. 3A schematically illustrates matches between keywords and symbols according to one embodiment of the present invention. The matching processing is executed by keywords, e.g. the identification code, the patient's name, the gender, the symbol or a combination thereof. In this regard, character of content summary record are 00001325, Lee, Whity, and Man.

Reference is made to FIG. 3B. FIG. 3B schematically illustrates area matches according to one embodiment of the present invention. The matching processing is executed by keywords, e.g. the identification code, the patient's name, the gender, the symbol, or a combination thereof. Additionally, characters are extracted according to a definition information 18 of respective keyword. For example, the definition information is similar to an abscissa, an ordinate, height or width. Thus, extracted characters are the same as those of FIG. 3A.

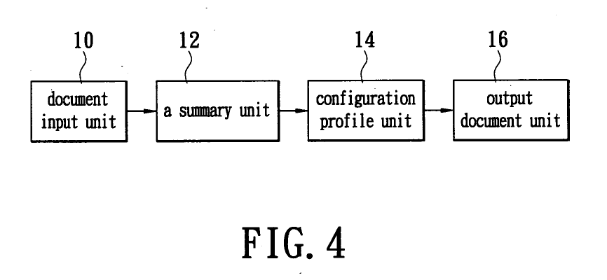

Reference is made to FIG. 4. FIG. 4 schematically illustrates a block diagram of a device for configuring a variety of medical information according to the present invention. The present invention includes a document input unit 10, a summary unit 12, a configuration profile unit 14 and an output document unit 16. The document input unit 10 is used to collect documents in a variety of medical information formats, and the summary unit 12 is used to summarize the documents in a variety of medical information formats within the document input unit in a content summary method in conformity with a configuration rule. The configuration profile unit 14 configures documents in a variety of medical information formats within the document input unit in conformity with the configuration rule into a document in a certain format by the summary unit 12. The output document unit 16 outputs the document in a certain format.

As described above, the present invention provides fast searching when the physician diagnoses patients by the document in a certain format. Besides, the physician needs not read several medical information format documents to relieve the physician's workload.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A method for configuring a variety of medical information, the steps comprising:
determining whether a configuration profile exists;
accessing the configuration profile stored within a storage medium;
inputting a new configuration profile or modifying an existent configuration profile; and
saving the configuration profile to the storage medium.

2. The method as claimed in claim 1, wherein if the configuration profile exists in the step of determining whether a configuration profile exists, then the configuration profile is stored within the storage medium, and if the configuration does not exist, then a blank configuration profile is created.

3. The method as claimed in claim 1, wherein the configuration profile is generated by extracting information and a borderline of the configuration profile is generated by employing a portable document format.

4. The method as claimed in claim 1, wherein a new configuration profile is created or an existent configuration profile is modified in the step of inputting.

5. The method as claimed in claim 1, wherein it is determined whether the configuration profile is saved in the step of creating the new configuration profile or modifying existent configuration profile.

6. The method as claimed in claim 5, wherein if the configuration profile is saved, then the configuration profile is saved to the storage medium.

7. A summary method for configuring a variety of medical information, the steps comprising:
sequentially inputting a plurality of medical information format documents;
extracting a certain format from various medical information documents in conformity with a configuration rule of a configuration profile;
executing a matching process to be in conformity with the configuration rule of the configuration profile by the certain format;
determining whether the various medical information documents are in conformity with the matching process; and
creating a content summary record.

8. The summary method as claimed in claim 7, wherein the various medical information documents are edited into webpage-like medical information supported by unified resource locator (URL), or the various medical information documents are created by any one medical information format.

9. The summary method as claimed in claim 7, wherein information is extracted to generate the configuration profile and employs a portable document format to generate a borderline of the configuration profile.

10. The summary method as claimed in claim 7, wherein the configuration rule is an identification code, a patient's name, gender, symbol, or a combination thereof.

11. The summary method as claimed in claim 7, wherein the configuration rule is a region of interest.

12. The summary method as claimed in claim 7, wherein the matching process comprises matching of keywords/symbols, matching of regions of interest, or matching of a combination thereof.

13. The summary method as claimed in claim 12, wherein the keywords/symbols is a default.

14. The summary method as claimed in claim 12, wherein the matching of regions of interests includes part of or all characters thereof.

15. The summary method as claimed in claim. 7, wherein if the various medical information format documents exist in the step of determining whether the various medical information format documents are in conformity with the matching process, then a content summary record is created, and if the various medical information format documents do not exist, then all medical information format documents are processed in accordance with the configuration rule.

16. The summary method as claimed in claim 15, wherein if all of the medical information format documents are completely processed in accordance with the configuration rule in the step of determining whether all of the medical information format documents, then processing stops, and if all of these medical information format documents are not completely processed, then a new content summary record is created responsive to are in conformity with the matching process next medical information format.

17. A device for configuring a variety of medical information, comprising:
a document input unit, used to collect documents in a variety of medical information formats;
a summary unit, used to summarize the documents in a variety of medical information formats within the document input unit in a content summary method in conformity with a configuration rule;
a configuration profile unit, wherein the configuration profile unit configures documents in a variety of medical information formats within the document input unit in conformity with the configuration rule into a document in a certain format; and
an output document unit, outputting documents in a certain format.
